(19) United States
(12) Patent Application Publication
(10) Pub. No.: US 2009/0256698 A1
(43) Pub. Date: Oct. 15, 2009

(54) Brake light warning system with early warning feature

(76) Inventor: Estevan Bonilla, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 12/384,439

(22) Filed: Apr. 3, 2009

Related U.S. Application Data
(60) Provisional application No. 61/123,546, filed on Apr. 10, 2008.

(51) Int. Cl. B60Q 1/44

(52) U.S. Cl. 340/479

(57) ABSTRACT

A brake light warning system provides a warning to nearby motorists whose vehicles are within a warning area adjacent a user vehicle. The warning system may provide a visual warning to these motorists by illuminating one or more brake lights of the user vehicle. A user alert device may also be activated to alert the user to a nearby vehicle that is within the warning area. The warning area may be fixed or may bet set based on the speed of the user vehicle to warn nearby motorists that they are too close to the user vehicle. The warning system may provide a warning via a brake light without activating the braking system of the user vehicle. The warning system may utilize components of the user vehicle to detect vehicle speed, nearby vehicles, provide warnings, provide alerts, or a combination thereof.

### CROSS-REFERENCE TO RELATED APPLICATION

This application claims priority to U.S. Provisional Application No. 61/123,546 entitled Watching Your Back, filed Apr. 10, 2008.

### BACKGROUND OF THE INVENTION

1. Field of the Invention

The invention relates generally to vehicle warning systems and in particular to a brake light warning system with an early warning feature for motor vehicles.

2. Related Art

Tailgating is an undesirable and unfortunately common aspect of traveling on roadways. Tailgating is not only a traffic violation but also an annoyance and safety hazard. A person being tailgated often becomes agitated because of the increased risk of a rear end collision caused by the small distance between his or her vehicle and the vehicle immediately behind. Not surprisingly, this can prompt aggressive driving and even road rage which are both dangerous to all parties involved as well as nearby motorists.

Tailgating also is a common cause of rear end accidents. As is known, the reduced distance between vehicles decreases the time a motorist has to react and the time a vehicle has to stop to avoid a collision. These accidents can range to relatively minor to severe.

Little has been done to address the problem of tailgating. As stated above, tailgating is generally illegal, yet it continues to occur and cause accidents. Some motorists have resorted to self help measures such as slowing down or slamming on the brakes to stop from being tailgated. These measures are ineffective and are themselves dangerous. In addition, these measures may actually incite further tailgating and escalate the situation into a confrontation.

Of course, a person being tailgated may simply shift lanes and allow a tailgating motorist to pass. However, this is impossible or dangerous in some circumstances such as a two lane highway or where traffic prevents a safe lane change. In addition, this requires the person subject to tailgating to remove him or herself from a dangerous situation which the person did not cause which is generally unfair to motorists who operate their vehicles with care and consideration.

From the discussion that follows, it will become apparent that the present invention addresses the deficiencies associated with the prior art while providing numerous additional advantages and benefits not contemplated or possible with prior art constructions.

### SUMMARY OF THE INVENTION

A brake light warning system is provided herein. In general, the warning system warns nearby motorists that they are following too closely, tailgating, or otherwise operating their vehicle at an unsafe distance. The warning system provides automated warnings and thus does not require user intervention. Also, the warning system does not slow the user vehicle when providing a warning to nearby motorists. An alert may be provided to the user that one or more nearby vehicles are in close proximity to the user vehicle.

The warning system may be configured in various ways. In one embodiment, the warning system comprises one or more proximity sensors configured to emit one or more signals to detect a proximity of one or more nearby vehicles by a reflection of the one or more signals, and a speed sensor configured to determine a speed of the motor vehicle. The proximity sensors may be located at a rear end of the motor vehicle. A warning area behind the motor vehicle having a size within the range of the signals may also be provided.

The warning system may include a warning device comprising one or more brake lights of the motor vehicle and configured to provide a visual warning to one or more nearby motorists. Also, a user alert device configured to provide an alert to a user of the motor vehicle.

A controller in communication with the one or more proximity sensors and the speed sensor may also be provided. The controller may be configured to activate the user alert device and the one or more brake lights when the proximity of the one or more nearby vehicles is within the warning area. In addition, the controller may be configured to set the size of the warning area based on the speed of the motor vehicle. Activation of the warning device may occur by the controller flashing the one or more brake lights without slowing the motor vehicle when the proximity of the one or more nearby vehicles is within the warning area.

The controller may receive the proximity of the one or more nearby vehicles via wireless communication with the one or more proximity sensors. Also, the controller may activate the user alert device via wireless communication with the user alert device. It is noted that the user alert device may comprise a light whereby the user alert device is configured to provide a visual alert. Alternatively, or in addition, the user alert device may comprise a speaker whereby the user alert device is configured to provide an audio alert.

The controller maybe configured to set the size of the warning area based on the speed of the motor vehicle whereby the length of the warning area is expanded as the speed increases and reduced as the speed decreases. Alternatively or in addition, the controller may be configured to set the size of the warning area based on the speed of the motor vehicle whereby the length of the warning area is 6 feet for every 10 miles per hour of the speed of the motor vehicle.

In one embodiment, a vehicle proximity warning system for a user vehicle for alerting an operator of a secondary vehicle of their proximity to the user vehicle is provided. The warning system may comprise one or more sensors associated with the user vehicle, and configured to provide an output indicative of the secondary vehicle proximate a rear end of the user vehicle. At least one warning device associated with the user vehicle may be provided as well. The warning device may be configured to emit a warning to the operator of the secondary vehicle. In addition, a controller configured to receive said the output from the one or more sensors and to activate the at least one warning device when the secondary vehicle is proximate the rear end of the user vehicle may be included as part of the warning system. A warning device may comprise one or more brake lights of the user vehicle. The controller, the one or more sensors, and the warning device may be supported at a position adjacent the rear window of the user vehicle by a housing if desired.

The warning system may include a user alert device in communication with the controller and configured to provide an alert to the operator of the user vehicle whereby the controller is configured to activate the user alert device when the secondary vehicle is proximate the rear end of the user vehicle.

In addition, the warning system may include a speed sensor in communication with the controller and configured to detect a speed of the motor vehicle whereby the controller is configured to set the size of a warning area based on the speed of the motor vehicle. The controller in these embodiments may be configured to activate the at least one warning device when the secondary vehicle is determined to be within the warning area.

A method of providing a warning to an operator of a secondary vehicle of their proximity to a user vehicle is also provided herein. In one embodiment, the method comprises detecting a presence of the secondary vehicle in proximity to a rear end of the user vehicle utilizing one or more sensors associated with the user vehicle while the user vehicle is travelling forward, and determining if the nearby vehicle is within a warning area of the user vehicle. When the proximity of the secondary vehicle is within the warning area, one or more warning devices associated with the user vehicle may be activated to cause the one or more warning devices to emit a warning signal to the operator of the secondary vehicle of the proximity of the secondary vehicle to the user vehicle.

Activating the one or more warning devices may comprise activating one or more brake lights of the user vehicle without activating a braking system of the user vehicle. Also, activating the one or more brake lights may comprise flashing the one or more brake lights.

The method may include detecting a speed of the user vehicle with a speed sensor, and setting the size of the warning area based on the speed of the user vehicle as well. Also, a user alert device associated with the user vehicle may be activated to emit an alert signal to an operator of the user vehicle of the proximity of the secondary vehicle to the user vehicle.

A housing may be secured at a rear portion of the motor vehicle as part of the method. The housing may be configured to support the one or more proximity sensors and a controller therein. The controller may be configured to set the warning area, activate the one or more brake lights, and activate the user alert device.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIGS. 1A-1B illustrates the components of an exemplary brake light warning system;

FIGS. 2A-2B illustrates the operation of an exemplary brake light warning system and warning area;

FIG. 3 illustrates an exemplary brake light warning system having a variable warning area;

FIG. 4 is a flow diagram illustrating the operation of an exemplary controller according to an embodiment of the brake light warning system; and

FIG. 5 is a perspective view of an exemplary housing according to an embodiment of the brake light warning system.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the brake light warning system herein protects users from the dangers of tailgating motorists. In one or more embodiments, this is accomplished by a providing notification or message to motorists when they are in close proximity to the user's vehicle. The system may sense when a vehicle is at an unsafe distance and activate the brake lights or another warning device to alert a tailgating motorist of the need to maintain a safe distance. The system may also activate an alert to notify the user that a vehicle is tailgating or in close proximity to the user's vehicle. As referred to herein, the user will typically be a driver or operator of a motor vehicle.

The brake light warning system is advantageous in that it provides a warning to motorists who have come too close to the user's vehicle. This may make the motorist conscious of the close proximity the motorist's vehicle to the user's vehicle. For example, a motorist who is on the phone, listening to music, or texting, lost, or otherwise not focused on driving may be made aware of his or her proximity to the user's car allowing the motorist to move to a safer distance.

The warning provided notifies tailgating motorists of a variety of hazards their unsafe driving is causing. To illustrate, tailgating motorists are warned to maintain a proper and safe distance from the user's vehicle, and of the risks they present to themselves and the user (as well as other nearby motorists). In this manner, tailgating motorists are encouraged to respect the safety of the user and other motorists, and to obey laws against tailgating. This leads to a reduction in rear end and other similar accidents which, it is noted, reduces traffic congestion and associated inconveniences caused by such accidents. As a consequence, insurance claims may be reduced which benefits motorists at large.

The brake light warning system is also advantageous in that it automatically provides a warning to tailgating motorists without the need for user action. In one embodiment for example, the system may automatically activate the user's brake lights when a vehicle is within a certain proximity. In this manner, a warning is provided to a tailgating motorist without slowing the user's vehicle because the brake lights illuminate without activation of the brakes themselves. In many situations, slowing the user's vehicle in response to a tailgating motorist is dangerous because the motorist is already in close proximity to the user's vehicle. There may already be a high risk of a rear end collision which is made worse by tapping or applying the brakes to discourage tailgating. The system herein provides a warning to the motorist without slowing the user's vehicle and thus provides a warning without exacerbating a dangerous situation.

By utilizing the user's brake lights to provide a warning, the brake light warning system provides the benefit of an easily (if not universally) recognized warning to tailgating motorists. As is known, brake lights generally cause motorists to slow down because they recognize that the vehicles ahead are slowing down. Thus, the use of the user's brake lights as a warning also causes following motorists to slow down. Because the system does not actually slow the user's vehicle (but only activates the brake lights), the tailgating motorist's reduction in speed increases the distance between the user's vehicle and such motorist's vehicle. It is noted, as will be described below, that other warning devices besides brake lights may be used in some embodiments of the system.

Another advantage of the brake light warning system is that a warning may also be provided to the user of the system. The user may then utilize defensive driving techniques to avoid a dangerous situation. For example, a visual or audible warning may be provided to the user to alert the user to a vehicle that is tailgating the user's vehicle. This allows the user to take action if the tailgating motorist continues to remain within an unsafe distance. For example, the user may allow the tailgating motorist to pass, change lanes, or the like. In this manner, the user may avoid a risky or dangerous situation. This is beneficial especially in situations where the user has not noticed a tailgating motorist such as on long road trips where the user's attention may be on the road ahead.

It is contemplated that a reduction to insurance premiums or other incentives may be given to a user as a result of installing or having the brake light warning system. This may occur in circumstances where the system reduces rear end or other accidents enough to warrant a reduction in premium amount. Of course, any such reductions will be determined by the user's insurance provider.

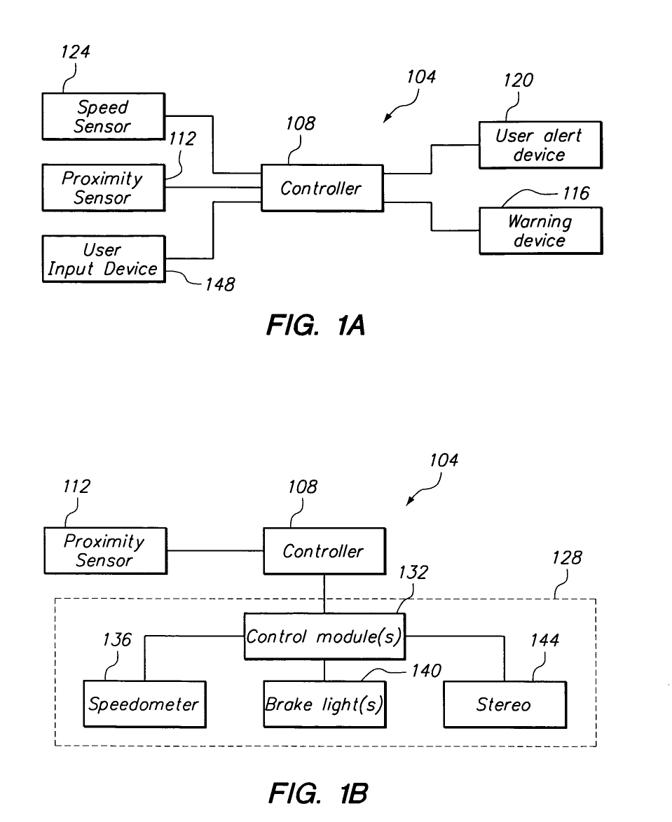

The brake light warning system will now be described with regard to the figures. FIG. 1A is a block diagram illustrating the components of an exemplary brake light warning system. The warning system 104 may comprise a controller 108 in communication with various sensors and warning/alerting devices. In the embodiment shown, the controller 108 is in communication with a proximity sensor 112 and a speed sensor 124 as well as a user alert device 120 and a warning device 116. Communication between the components of the warning system 104, such as those illustrated, may be through one or more wired or wireless communication pathways. In wired embodiments, communication may occur via electrical, optical, or other signals which may be carried on one or more physical conduits. In wireless embodiments, communication may occur wirelessly via electromagnetic signals, RF signals, infrared signals, or the like.

In general, the controller 108 receives sensor information, processes the information to determine whether or not to activate one or more warnings or notifications. The controller 108 may be control logic, a circuit, a microprocessor, or the like. In one or more embodiments, the controller 108 may execute one or more instructions to perform the functions of the warning system 104 as discussed herein. The instructions may be executable data, code, or the like stored on a memory device within the controller 108 or in communication with the controller. In addition or alternatively, the instructions may be hard wired into the controller 108 itself or control logic of the controller 108. In one or more embodiments, the instructions may comprise machine readable code.

For example, the controller 108 may execute one or more instructions to receive sensor information and calculate or otherwise determine the distance of one or more nearby vehicles. Instructions for performing one or more calculations utilizing the sensor information may be provided as well. For example, there may be instructions for determining the speed of the user vehicle, nearby vehicles or both based on sensor information. In addition, there may be instructions which determine when a warning or alert should be activated depending on the speed, distance, or both of one or more nearby vehicles or the user vehicle as described further below.

The controller 108 may be in communication with one or more warning devices 116 in one or more embodiments. In general, the warning device 116 is used to warn or notify other drivers that they are tailgating or otherwise too close to the user's vehicle. In one embodiment, the warning device 116 may provide a visual warning. In other embodiments, an audio warning, or both an audio and visual warning, may be provided. Typically, such warning will be provided by one or more light or sound emitters, such as lights or speakers, respectively.

It is contemplated that one or more electronic signs or displays may be used as a warning device 116. These types of warning devices 116 may provide text or images which convey a warning to tailgating motorists. In addition, information, such as the distance between vehicles, vehicle speed, or the like may be conveyed.

It is also contemplated that light of a specific color may be used to provide a warning. For example, a warning device 116 may be configured to emit light of a specific color to warn motorists. In one embodiment, the warning device 116 may emit a blue light as a warning that the motorist is too close to the user's vehicle. Of course, other colors may be used. In addition or alternatively, it is contemplated that lights may be flashed or blinked at various rates to provide a warning. This is beneficial in that it distinguishes the warning from the constant lighting provided by a vehicle's brake lights during braking. In addition, flashing or blinking lights may also be more attention getting.

It is noted that a warning light may also blink or flash for some situations and provide constant illumination in other situations. For example, when the vehicle is traveling at low speeds the warning light may blink while the warning light may be constantly illuminated at high speeds (or vice versa). This is beneficial in that constant illumination may provide a different warning as the risk of collision increases. For example, a motorist may ignore a blinking warning but heed a constantly illuminated warning in some situations.

In one or more embodiments, one or more warning devices 116 may be located at the rear of a user's vehicle. This allows motorists behind the user's vehicle to perceive the warning from at least one of the warning devices 116. Of course, a warning device 116 may be located elsewhere inside or outside a vehicle. For example, a warning device 116 may be located inside a vehicle on the rear deck panel adjacent or beneath the vehicle's rear window. As stated, a warning device 116 may also be located exterior to the vehicle.

A warning device 116 may be secured to a user's vehicle with one or more fasteners, welds, adhesives, or the like. In one or more embodiments, a magnet or suction cup, both, or the like may be used. For example, a warning device 116 may be secured to a vehicle's body by one or more magnets or to a vehicles glass (or other smooth surface) by one or more suction cups.

In one embodiment, a warning device 116 may be one or more components of the user's vehicle rather than a separate device secured or mounted to the vehicle. For example, a warning device 116 may be one or more brake lights of a vehicle. In this embodiment, the controller 108 utilizes the brake lights of a vehicle to warn tailgating motorists. Such warning may occur by the controller 108 activating or turning on one or more of the vehicles brake lights. Of course, the vehicle's other lights may be utilized as warning devices 116 if desired. However, it is noted that utilizing the brake lights is advantageous in that it provides an easily recognizable warning, as discussed above. As will be understood, where a component of a user's vehicle is used as a warning device, the warning device will typically already be secured to the vehicle.

The controller 108 may also be in communication with a user alert device 120. In general, a user alert device 120 alerts a user that a motorist is close to or tailgating the user. The user alert device 120 may utilize an audio alert, visual alert, or both to perform its function. For example, a sound, light, or both may be provided by the user alert device 120 to alert a user to a tailgating motorist. The user is then aware of the motorist and may initiate one or more defensive driving techniques if necessary.

The user alert device 120 may be located at various locations within the user's vehicle. Typically, the user alert device 120 will be located near the driver's seat or at the front of the vehicle's interior. In one embodiment, the user alert device 120 is on or near the instrument panel or dash board of the user's vehicle so as to easily get the attention of the user when an alert is produced. Of course, the user alert device 120 may also be located elsewhere, including on the exterior of the vehicle, so long as the user may still be alerted by the device.

It is contemplated that the user alert device 120 may be a component of the user's vehicle. For example, one or more speakers, radio/sound systems, or interior lights of the vehicle may be used as a user alert device 120. In addition, one or more of a vehicle's displays may be used as a user alert device 120. For example, a vehicle's existing heads-up display (HUD), navigation or other screen, or the like may be a user alert device 120.

To determine when to activate a warning or alert, in one or more embodiments, the controller 108 may be in communication with one or more speed sensors 124, one or more proximity sensors 112, or a combination thereof. Typically, but not always, the controller 108 will be in communication with at least a proximity sensor 112. In general, the proximity sensor 112 detects the distance to a vehicle near or in the vicinity of the users vehicle. The readings or information from the proximity sensor 112 may be communicated to the controller 108 so that the controller 108 may activate one or more warnings or alerts when appropriate.

The proximity sensor 112 may utilize various measurement techniques, now known or later developed, to determine the proximity of another vehicle. In one embodiment, the proximity sensor 112 may emit one or more signals to determine the proximity of another vehicle. For example, the proximity sensor 112 may emit an acoustic, electromagnetic, light, radio frequency, or other signal and determine the proximity of another vehicle by the time it takes the reflection of the signal to return to the proximity sensor 112. Various characteristics of the reflected signal, such as its strength, may also or alternatively be used to determine the proximity of another vehicle. It is contemplated that known range or distance finding technology may be used in some embodiments. For example, the proximity sensor 112 may utilize radiofrequency, laser, or acoustic range finding in one embodiment. In another embodiment, RADAR, LIDAR, or the like may be used to determine the proximity of another vehicle.

It will be understood that various sensors which allow the distance, proximity, or presence of one or more vehicles near the user vehicle may be used in addition to or instead of proximity sensors 112. For example, presence detectors, or the like may be used. In these embodiments, the presence of a vehicle within a particular proximity may cause the controller to activate a warning or alert. The range, sensitivity, or other sensing characteristic of a sensor may be increased or decreased to detect the presence of vehicles at various distances.

As will be described further below, a proximity sensor 112 may be positioned at various locations on a user's vehicle. In one or more embodiments, one or more proximity sensors 112 may be located at the rear of the vehicle. This allows the proximity sensors 112 to detect vehicles behind the user's vehicle which is highly advantageous in detecting tailgating vehicles. Of course, proximity sensors 112 may be located at the sides or front of the vehicle as well if desired.

It is contemplated that one or more proximity sensors 112 may be used to detect vehicles near various portions of the user's vehicle. For example, one or more sensors may be used to detect vehicles near the left rear of the user's vehicle while one or more other sensors may be used to detect vehicles near the right rear of the vehicle. In one exemplary embodiment, an array of proximity sensors 112 may be positioned along a user vehicle's bumper, trunk, rear skirt, or other rear panel or surface of the user vehicle. It is contemplated that the proximity sensors 112 may have the resolution or sensitivity to discern the proximity of a plurality of vehicles behind or near the user's vehicle.

The proximity sensors 112 may be oriented in a particular direction or directions in one or more embodiments. This allows the proximity sensors 112 to detect the proximity of nearby vehicles within particular areas adjacent the user vehicle. To detect tailgating vehicles for example, one or more proximity sensors 112 may be oriented such that they are pointed behind the vehicle. The one or more signals would then be emitted behind the user vehicle to allow the proximity of nearby vehicles behind the user vehicle to be detected.

Typically, a proximity sensor 112 will be located such that at least a portion of the sensor is exterior to the user's vehicle. In this manner the signals emitted and/or received by the proximity sensors 112 are unhindered by portions of the vehicle. Of course, proximity sensors 112 may be located within a user's vehicle or a portion thereof in some embodiments. For example, some signals emitted and/or received by a proximity sensor 112, such as radiofrequency or microwave signals, may pass through physical portions of the user's vehicle. Other types of signals may pass through particular portions of the user's vehicle. For example, laser or light based signals may pass through a vehicles windows or other transparent portions such as brake or other light covers. In one embodiment, one or more light or laser based proximity sensors 112 may be located such that their signals may be emitted and/or received through the rear window of a vehicle.

Some vehicles may be equipped with proximity sensors 112 already. For example, some vehicles include proximity sensors 112 to guide a driver in parallel or other parking situations. It is contemplated that these existing proximity sensors 112 may be used by the controller 108 in one or more embodiments. In this manner, the warning system 104 may be included or used to retrofit existing vehicles with the warning features disclosed herein.

Optionally, the controller 108 may be in communication with one or more speed sensors 124. In general, a speed sensor 124 may be used to detect the speed at which the user's vehicle is travelling. Various devices may be used as a speed sensor 124 including the vehicle's own speedometer, or GPS system. In some embodiments, a mechanical or electronic speed sensor 124 may be used. In general, such speed sensors 124 measure the a vehicle's speed by comparing the vehicle's motion relative to a stationary reference point. This may be accomplished by emitting one or more signals and measuring the reflection of the signals or a characteristic of the signals. It will be understood, that various devices, now known or later developed, for determining a vehicle's speed may be utilized with the warning system 104 herein. It is noted that some proximity sensors 112 may be capable of detecting the speed of the user vehicle. In these embodiments, it is contemplated that the same sensor, such as a RADAR or LIDAR sensor, may detect both the proximity of nearby vehicles as well as the speed of the user vehicle.

The speed sensor 124 is advantageous in that it allows the controller 108 to change the distance within which a warning or alert is activated depending on the current speed of the user's vehicle. For example, in slow moving traffic, a vehicle in close proximity to the user's vehicle may not pose a high risk because stopping distances are reduced due to the slow speed of the vehicles. Thus, in these cases it is beneficial to disable or reduce the distance within which a warning or alert is activated. At higher speeds, a warning or alert may be activated even though the vehicle behind the user's vehicle is further away because of the increased stopping distances caused by the higher speed.

Though the speed sensor 124 itself does not provide the speed of a nearby vehicle, it may be assumed, in one or more embodiments, that the nearby vehicle is travelling at a similar speed as the user's vehicle. Alternatively, or in addition, the user vehicle's speed may be combined with proximity information from one or more proximity sensors 112 to determine the speed of a nearby or tailgating vehicle. In this manner, the speed of nearby vehicles, their proximity, or both may be used by the controller 108 in determining whether or not to activate a warning or alert.

One or more user input devices 148 may also be provided in some embodiments. In general, the user input devices 148 will be used to accept input from a user. In one embodiment, user input devices 148 may be used to configure or setup the warning device. For example, a user input device 148 may be used to set one or more warning areas. In addition, the type of warning provided or type of alert provided may be configured using a user input device 148. For instance, the warning system may offer one or more warning or alert types which may be selected by using a user input device 148. To illustrate, a blinking or constantly illuminated warning or alert may be selected using a user input device 148. It is contemplated that a user input device 148 may be a button or other control in communication with the controller in one or more embodiments.

It is noted that the warning system 104 may communicate with a vehicle's components in a variety of ways to obtain sensor information, activate one or more warnings or alerts, or both. For example, the warning system 104 may be directly connected to a speedometer, brake or other light, speaker, or other component of a vehicle. This may be accomplished through a wired connection such as an electrical or optical connection, or may be accomplished wirelessly.

The warning system 104 may also communicate with vehicle components through one or more control modules 132 of a vehicle's electronics 128, such as shown in FIG. 1B. As is known, a control module 132 is a computer, controller, control logic, circuit, or the like which operates or controls one or more components of the vehicle. For example, a control module 132, such as a vehicle's onboard computer, may operate the vehicle's braking system, lighting system, A/C system, sound system, safety system, and the like. The warning system 104 may interface with such a control module 132 to provide the warning features discussed herein.

As shown in FIG. 1B, the warning system 104 has a controller 108 which is in communication with one or more control modules 132 of a vehicle's electronics 128. In this manner, sensor information, such as speed from the vehicle's speedometer 136 may be received from the vehicle. Though shown as having its own proximity sensor 112, it is contemplated that in vehicles equipped with proximity sensor, the warning system 104 may utilize the vehicle's proximity sensor through a direct connection or via one or more control modules 132 of the vehicle. In these embodiments, a separate proximity sensor 112 may not be provided.

The controller 108 may also communicate with one or more warning devices or user alert devices through a control module 132. For instance, the controller 108 may activate a warning device comprising one or more brake lights 140 to provide a warning to nearby or tailgating motorists. In addition, the controller 108 may activate an audio alert via the stereo 144 of a user vehicle. Of course, as stated above, the warning system 104 may also activate a warning or alert by a direct connection to the warning or user alert devices as well.

In one or more embodiments, the controller 108 may be integrated into the motor vehicle. For example, the controller 108 may be a component of the motor vehicle, such as a circuit, control logic, control module, processor, or the like that is provided with the motor vehicle. In one or more embodiments, such a controller 108 may execute one or more instructions (as described above for example) to perform the functions of the warning system.

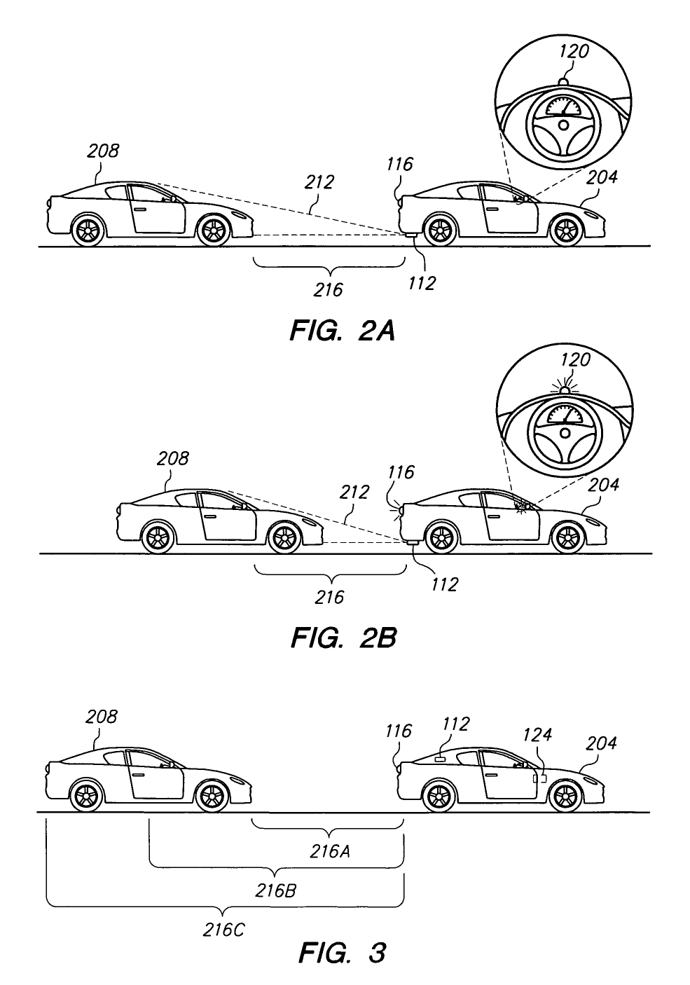

FIGS. 2A-2B are side views of a user's vehicle 204 and a nearby vehicle 208 behind the user's vehicle illustrating operation of the warning system in one or more embodiments. Though illustrated as cars, it will be understood that the warning system will work with various vehicles, including but not limited to trucks, motorcycles, and bicycles.

As shown, the user vehicle 204 is followed by a nearby vehicle 208. The user vehicle 204 has a proximity sensor 112 at its rear end. Of course, a plurality of proximity sensors 112 may be provided in one or more embodiments. As indicated by the dashed lines, the proximity sensor(s) 112 may emit and/or receive one or more signals 212 to determine the proximity of the nearby vehicle 208. In practice, it is noted that the signals 212 will typically not be visible.

Typically, the one or more signals will have a range. As used herein, the range of the one or more signals will refer to the distance within which the one or more signals can be used to detect the proximity of one or more nearby vehicles. It will be understood that this may depend to a certain extend, on the power and sensitivity of the one or more proximity sensors 112 in some embodiments. A warning area, which will be described further below, may be defined by the range of the one or more signals. In one or more embodiments for example, the warning area will be an area within the range of the one or more signals.

The user vehicle 204 as shown includes a warning device 116 in the form of a brake light and a user alert device 120 in the form of an alert light near the vehicle's instrument panel. In this manner, the warning device 116 may warn nearby or tailgating motorists as well as the user.

In the embodiments of FIGS. 2A and 2B, a warning area 216 is also illustrated. The warning area 216 is the distance or area within which the warning system will activate an alert or warning. To illustrate, in FIG. 2A, the nearby vehicle 208 is outside the warning area 216 and no other vehicle is present within the warning area 216. Thus, the warning device 116 and user alert device 120 remain inactive. In FIG. 2B, the nearby vehicle 208 has moved to within the warning area 216. For this reason, the warning device 116 and user alert device 120 have been activated. In this case, the brake light and alert light of the user vehicle 204 have been illuminated. In this manner, the user and the nearby motorist are made aware that the nearby vehicle 208 is following too closely or is tailgating. Then, the user may engage one or more defensive driving techniques, the motorist may increase his or her distance to the user vehicle, or both.

It is noted that the warning system activates the warning device 116 without activating the braking system of the user vehicle. Thus, the user vehicle is not slowed down even though the warning device 116 (which may be one or more brake lights) is illuminated or activated. It can be seen from FIG. 2B that slowing the vehicle down by braking (as is commonly done in response to tailgating motorists) increases the risk of a collision because the nearby vehicle is already within close proximity to the user vehicle. The warning system herein provides a warning through one or more brake lights with the advantage of not slowing the user vehicle. In addition, the warning system is automated and thus a warning is automatically provided without user interaction, such as pumping the brakes of the user vehicle.

In one or more embodiments, the warning area 216 may be a fixed distance or area behind the user vehicle 204. For example, as shown in FIGS. 2A and 2B the warning area 216 is a fixed distance from the user vehicle 204. Vehicles that enter the warning area 216 trigger a warning or alert from the warning system regardless of the speed at which the user vehicle or other vehicles are travelling.

The warning area 216 may be fixed at a distance which is deemed a generally safe distance for vehicles to follow. This may take into account average stopping distances of vehicles including that of the user vehicle. It is noted that the warning area 216 may be limited to areas directly behind the vehicle in one or more embodiments. In other embodiments, the warning area 216 may include the user vehicle's blind spot or spots. This focusing of the warning area 216 may be accomplished by orienting or targeting one or more proximity sensors 112 such that only vehicles that enter these areas around the user vehicle 204 will cause an alert or warning. Alternatively, or in addition the warning area 216 may be set or adjusted to include these areas around the user vehicle 204.

In one embodiment, the warning area 216 may be set to a fixed distance by the controller of the warning system. For example, the controller may include one or more preset fixed warning areas 216 included by its manufacturer. Alternatively, or in addition, a warning area 216 may be set by numerical or other input from a user that is received by the controller. For example, a user may input the size of the warning area 216 through one or more buttons or other input devices.

The warning area 216 may also vary in one or more embodiments. This is illustrated in the embodiment of FIG. 3 which includes one or more speed sensors 124. It is noted that though shown at a particular location within the user vehicle 204, speed sensors 124 may be located at various locations within or on a user vehicle, especially where the speed sensors 124 communicate wirelessly.

As stated, a speed sensor 124 allows the warning system to determine the speed of the user vehicle 204, one or more nearby vehicles 208, or both. In this manner, speed may be an additional factor in determining whether or not to activate a warning or alert. To illustrate, at low speeds the warning area may be reduced because there is a lower risk of a collision. Also, where traffic is congested, vehicles may safely be driven within relatively close proximity to one another. Thus, as shown, a reduced warning area 216A may be utilized. This is beneficial because it allows vehicles to follow the user vehicle 204 closely without activating the warning or alert. In high traffic situations, repeatedly activating the warning or alert may become annoying or tiresome to the user and to motorists which may exacerbate road stress.

As vehicle speeds increase, the warning area may be accordingly expanded. For example, the warning area may be expanded as shown by warning area 216B. With warning area 216B, vehicles that would not have activated an alarm or warning with warning area 216A, would activate an alarm or warning. In this manner, nearby motorists or tailgating motorists are warned by the warning system at an expanded distance from the user vehicle 204. As speeds continue to increase the warning area may expand further. For example, the warning area may expand as shown by warning area 216C. It can thus be seen that as speeds increase warnings (and alerts) are activated at increased distances away from the user vehicle. This increases safety and reduces unnecessary or undesired warnings at lower speeds.

In the example of FIG. 3, the nearby vehicle 208 would trigger a warning or alert if the speed of the user vehicle 204 or the nearby vehicle are relatively high because such a speed would expand the warning area to those illustrated by warning area 216B and warning area 216C. At low speed, the nearby vehicle 208 would not trigger a warning or alert because, as shown, the nearby vehicle is not within the low speed warning area 216A. It is noted that these warning areas are not necessarily to scale and that the distance or size of warning areas based on speed, distance, or both may be set in various ways.

For example, a warning area may be set according to the speed of the nearby vehicle and an average or typical stopping distance for motor vehicles for a given speed. In one embodiment, the warning area for a given speed will be the average or typical stopping distance for a vehicle travelling at that speed. An offset distance may be added to increase safety in case the nearby vehicle has worse than average or typical stopping distances. Of course, an offset distance may also be subtracted if desired. Such subtraction may be advantageous in reducing unnecessary or undesired warnings if desired. In some embodiments, the user may be permitted to set the warning area to a fixed area or to one or more different areas according to the speed of the user vehicle.

It will be understood that the controller of the warning system may be configured to vary the size of the warning area based on the speed and distance of one or more vehicles. For example, the controller may execute one or more instructions to calculate the size of a warning area based on the speed of the user vehicle, nearby vehicle(s), or a combination thereof.

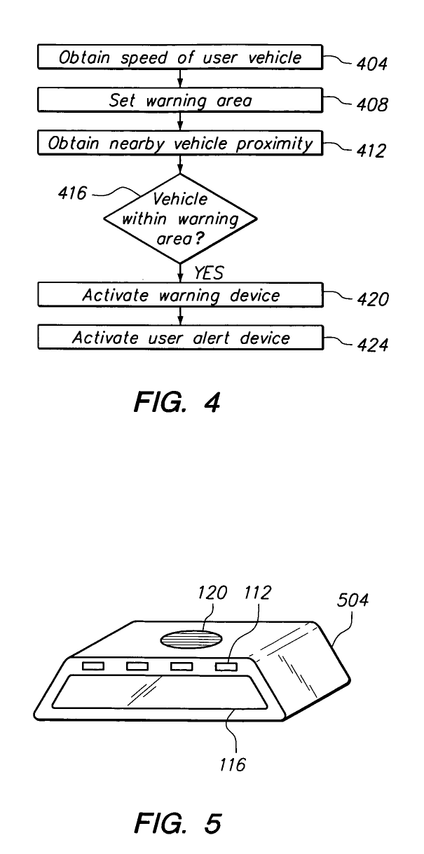

Operation of an exemplary controller of the warning system will now be described with regard to the flow diagram of FIG. 4. It is noted that in one or more embodiments, the controller may execute one or more instructions to operate in this manner.

At a step 404, the speed of the user vehicle may be obtained from one or more speed sensors. As stated, this information may be obtained from a speed sensor provided with the warning system or may be obtained from a speed sensor, such as a speedometer or GPS device, of the user vehicle.

At a step 408, the speed of the user vehicle may be used to set a warning area adjacent the user vehicle. In general, the warning area will be set such that a warning or alert is provided by the warning system when a vehicle comes within an unsafe speed of the user vehicle. Typically, the warning area will cover an area immediately behind the user vehicle so that tailgating motorists may be detected and warned.

It is noted that the length of a warning area may be set to a distance away from the rear of the user vehicle which is deemed safe for following vehicles. This allows the warning system to focus on detecting and warning tailgating drivers. Of course, the warning area may be moved, expanded, or reduced to increase or decrease the area within which nearby motorists are warned. This may be accomplished by repositioning one or more sensors of the warning system or increasing/decreasing the sensitivity or range of the sensors.

The width of a warning area may be also be set in one or more embodiments. For example, the width may be set according to the width of the user vehicle, typical lane width, or other size. In some embodiments, the width of a warning area may be set by the proximity sensors. For example, the proximity sensors may be arranged or configured to detect nearby vehicles within an area of a particular width. To illustrate, proximity sensors may be positioned along a user vehicle's rear bumper. In this manner, nearby vehicles within the width of the vehicle may be detected while vehicles outside that width may not be detected. Of course, the proximity sensors may be arranged or configured to detect vehicles within areas of various widths. For example, the proximity sensors may detect vehicles within the width of an average or typical lane or road.

The controller may perform one or more calculations to set the warning area. For example, in one embodiment, the controller may calculate a warning area by allowing for 6 feet of distance for every 10 miles per hour of speed. Thus, in one embodiment, the length of the warning area may be set, in feet, by multiplying the user vehicle's current speed by six. It can thus be seen that the warning area may expand as the speed of the user vehicle increases. This compensates for the additional risk of a collision as speeds increase.

Other ways of calculating the warning area may be used as well. For example, a warning area may be calculated by allowing for X amount of distance for every Y amount of speed. It is contemplated that the user may input distance values for X and speed values for Y to the controller in one or more embodiments. These values may also be preset by the manufacturer of the warning system.

It is contemplated that the controller may also take into account road or weather conditions in calculating the warning area. This allows the controller to expand the warning area in inclement weather or for hazardous road conditions. For example, the warning area may be expanded for slick roads, ice, or reduced visibility. Information regarding road conditions or weather may be obtained by the controller by sensors of the user vehicle or wireless or radio weather systems now known and later developed. In one embodiment, the controller takes temperature into account via a temperature sensor in communication with the controller. For example, low temperatures, such as those near or below freezing, may cause the warning area to be expanded by the controller due to the likelihood of freezing or icy conditions.

It is noted that some embodiments of the warning system may not utilize speed sensors. In these embodiments, step 404 may not be performed by the controller. In addition, setting the warning area in step 408 may comprise setting the warning area to a fixed distance or area such as provided to the controller by a user or by a manufacturer of the warning system. It is contemplated that the fixed distance may be adjusted by the user to expand or reduce the warning area in one or more embodiments.

INCLUDE ADDITIONAL INFORMATION REGARDING CALCULATION OF WARNING AREA IF DESIRED.

At a step 412, the proximity of any nearby vehicles (i.e. vehicles within sensor range) may be obtained by the controller through one or more proximity sensors. This information may then be analyzed with regard to the warning area. At a decision step 416, if the proximity of a nearby vehicle indicates that it is within the warning area a warning device may be activated at a step 420, and a user alert device may be activated at a step 424. Of course, if a user alert device is not preset or user alerts are not desired, the user alert device may not be activated. In one or more embodiments, the warnings or alerts may be flashing or constant illuminated lighting. Of course, other types of notifications, such as sounds, graphics, text, as described above, may be utilized as a warning or alert. In one embodiment, an audio alert including the distance of a nearby motorist's vehicle may be provided to the user through a user alert device comprising a speaker. It is noted that various alerts and warnings may be provided in combination. For example, an alert or a warning may include a visual as well as an audio notification.

The controller may perform one or more calculations to determine if a nearby vehicle is within a warning area. For example, in one embodiment, the proximity of a vehicle may be compared to the length of the warning area. If the proximity is within the length of the warning area, the controller may activate a warning and/or alert. If not, the controller may continue to monitor the warning area for vehicles. It is noted that because the proximity sensors may be targeted to various areas, such as an area of the road or lane immediately behind the user vehicle, the measure of proximity is sufficient to determine when a vehicle is too close to the user vehicle.

The components of the warning system may be located at various locations relative to the user vehicle. Because the components, such as the controller, warning device, user alert device, speed sensor, and proximity sensors may communicate via wired or wireless connections, these components may be located remote from one another. This can be seen in an embodiment where the controller communicates with a warning device at the rear of the user vehicle and a speed sensor at the front of the vehicle. Of course, this is exemplary and components may be positioned at other locations.

In one embodiment, one or more components of the warning system may be supported by a housing. In general, a housing is a structure which holds one or more components of the warning system at a particular position. The housing may also secure the components to the vehicle so that the components are positioned for proper operation and do not undesirably move when the user vehicle is in motion. The housing may be configured to protect components of the warning system as well. For example, the housing may be enclosed, be formed from a rigid material, be water resistant or water proof, or be insulated in one or more embodiments. This allows the components to be safely located in the interior or on the exterior of a user vehicle.

An exemplary housing 504 is illustrated in FIG. 5. As can be seen the housing 504 supports a warning device 116, user alert device 120, and one or more proximity sensors 112. In the embodiment shown, the warning device 116 comprises a light configured to emulate a brake light and a user alert device 120 comprising a speaker. The housing 504 may also support components internally such as a controller, a speed sensor, or other components of the warning device. It is contemplated that components that do not require external exposure to operate properly may be internal to the housing 504.

In this embodiment, the warning system is provided in a single unit. This is advantageous in that the warning system may be installed in a user vehicle by placing the warning system in or on the user vehicle. For example, the housing 504 shown may be placed on a rear deck of a user vehicle adjacent the rear window. The warning device 116 and proximity sensors 116 may be visible and operate through the rear window. It can be seen, that the warning system may be easily incorporated into a user vehicle in this manner.

In other embodiments, the housing 504 may support or contain a subset of all the warning system's components. For example, the housing 504 may support a controller and one or more proximity sensors 112 while the other components are remote from the housing. A controller may communicate with the remote components through one or more wired or wireless connections as stated above. To illustrate, in one embodiment, the warning device may be one or more brake lights remote from the housing which communicate with the controller within the housing via one or more wired or wireless connections. In another embodiment, the user alert device may be remote from the housing. It can thus be seen that other remote components may communicate in this manner with components within or supported by the housing. It is contemplated that in some embodiments, one or more separate housings 504 may be provided, each supporting a subset of the warning systems components.

A housing 504 may be secured to the user vehicle in one or more embodiments. For example, one or more fasteners, adhesive, or the like may be used to secure the housing. In one embodiment, a magnet, hook and loop material, or a suction cup may be used to secure the housing 504 to various surfaces of the exterior or interior of the user vehicle. This allows the housing 504 to be positioned such that its warnings are visible to nearby motorists and such that its proximity sensors may operate properly to detect the proximity of nearby or tailgating vehicles.

It can be seen that a housing 504 allows existing motor vehicles to be easily retrofitted with the warning system. For example, an embodiment where all the warning system's components are in a single housing 504 allows an existing vehicle to be retrofitted by simply securing the housing to the vehicle or placing the housing within the vehicle. The warning system may connect to a power supply, such as the vehicle's electrical system, or may include its own power source, such as a battery, solar panel, or combination thereof.

In other embodiments, the housing 504 may include openings for one or more connections to warning devices, user alert devices, various sensors, control modules, or other parts of a vehicle. In this manner, a motor vehicle may be retrofitted by placing the housing 504 on or within the vehicle and making the connections to the warning system components which are part of the motor vehicle. For example, as stated, a controller within the housing may be connected to the brake lights, stereo, or one or more sensors of the motor vehicle.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A brake light warning system for a motor vehicle comprising:
one or more proximity sensors configured to emit one or more signals to detect a proximity of one or more nearby vehicles, the one or more proximity sensors located at a rear end of the motor vehicle;
a speed sensor configured to determine a speed of the motor vehicle;
a warning area behind the motor vehicle having a size within a range of the one or more signals;
a warning device comprising one or more brake lights of the motor vehicle, the warning device configured to provide a visual warning to an operator of the one or more nearby vehicles;
a user alert device configured to provide an alert to an operator of the motor vehicle; and
a controller in communication with the one or more proximity sensors and the speed sensor, whereby the controller is configured to activate the user alert device and the one or more brake lights when the proximity of the one or more nearby vehicles is within the warning area, the controller configured to set the size of the warning area based on the speed of the motor vehicle.

2. The warning system of claim 1, wherein the controller flashes the one or more brake lights when the proximity of the one or more nearby vehicles is within the warning area.

3. The warning system of claim 1, wherein the controller receives the proximity of the one or more nearby vehicles via wireless communication with the one or more proximity sensors.

4. The warning system of claim 1, wherein the controller activates the user alert device via wireless communication with the user alert device.

5. The warning system of claim 1, wherein the user alert device comprises a light whereby the user alert device is configured to provide a visual alert.

6. The warning system of claim 1, wherein the user alert device comprises a speaker whereby the user alert device is configured to provide an audio alert.

7. The warning system of claim 1, wherein the controller is configured to set the size of the warning area based on the speed of the motor vehicle whereby the size of the warning area is expanded as the speed increases and reduced as the speed decreases.

8. The warning system of claim 1, wherein the controller is configured to set the length of the warning area based on the speed of the motor vehicle whereby the size of the warning area is 6 feet for every 10 miles per hour of the speed of the motor vehicle.

9. A vehicle proximity warning system for a user vehicle for alerting an operator of a secondary vehicle of their proximity to the user vehicle comprising:
one or more sensors associated with the user vehicle, the one or more sensors configured to provide an output indicative of the secondary vehicle proximate a rear end of the user vehicle;
at least one warning device associated with the user vehicle, the at least one warning device configured to emit a warning to the operator of the secondary vehicle;
a controller configured to receive said the output from the one or more sensors and to activate the at least one warning device when the secondary vehicle is proximate the rear end of the user vehicle.

10. The warning system of claim 9, wherein the at least one warning device comprises one or more brake lights of the user vehicle.

11. The warning system of claim 9 further comprising a user alert device in communication with the controller and configured to provide an alert to the operator of the user vehicle whereby the controller is configured to activate the user alert device when the secondary vehicle is proximate the rear end of the user vehicle.

12. The warning system of claim 9 further comprising a speed sensor in communication with the controller and configured to detect a speed of the motor vehicle whereby the controller is configured to set the size of a warning area based on the speed of the motor vehicle.

13. The warning system of claim 12, wherein the controller is configured to activate the at least one warning device when the secondary vehicle is determined to be within the warning area.

14. The warning system of claim 9 further comprising a housing configured to support the controller, the one or more sensors, and the warning device at a position adjacent the rear window of the user vehicle.

15. A method of providing a warning to an operator of a secondary vehicle of their proximity to a user vehicle comprising:
detecting a presence of the secondary vehicle in proximity to a rear end of the user vehicle utilizing one or more sensors associated with the user vehicle while the user vehicle is travelling forward;
determining if the nearby vehicle is within a warning area of the user vehicle; and
when the proximity of the secondary vehicle is within the warning area, activating one or more warning devices associated with the user vehicle to cause the one or more warning devices to emit a warning signal to the operator of the secondary vehicle of the proximity of the secondary vehicle to the user vehicle.

16. The method of claim 15 further comprising:
detecting a speed of the user vehicle with a speed sensor; and
setting the size of the warning area based on the speed of the user vehicle.

17. The method of claim 15, wherein activating the one or more warning devices comprises activating one or more brake lights of the user vehicle without activating a braking system of the user vehicle.

18. The method of claim 17, wherein activating the one or more brake lights comprises flashing the one or more brake lights.

19. The method of claim 15 further comprising activating a user alert device associated with the user vehicle to cause the user alert device to emit an alert signal to an operator of the user vehicle of the proximity of the secondary vehicle to the user vehicle.

20. The method of claim 14 further comprising securing a housing at a rear portion of the motor vehicle, the housing supporting the one or more proximity sensors and a controller therein whereby the controller is configured to set the warning area, activate the one or more brake lights, and activate the user alert device.
